(19) United States
(12) Patent Application Publication
(10) Pub. No.: US 2010/0242370 A1
(43) Pub. Date: Sep. 30, 2010

(54) TOP HUNG DOOR ASSEMBLY

(76) Inventor: Steven L. Trulaske, SR., St. Louis, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/732,784

(22) Filed: Mar. 26, 2010

Related U.S. Application Data
(60) Provisional application No. 61/165,111, filed on Mar. 31, 2009.

(51) Int. Cl. E05D 15/06

(52) U.S. Cl. 49/410; 49/409

(57) ABSTRACT

This top hung door assembly (10) for a merchandiser includes a pair of doors 12, 14 each having an upper frame member (20) including a metal reinforcing member (22). An upper track member (16) is provided including depending flange members (36) and (38) each having a roller mounting portion (48). A pair of spaced wheel assemblies (60) is provided including a bracket (50) having a lower portion (54) connected to the upper door frame and an upper portion (52) carrying a pair of rollers (60) received by the roller mounting portion (46). The upper track member (16) includes associate track members (46) having spaced notches (49) to facilitate mounting the doors. Also the flange members have flexible tips (44) facilitating the sealing and mounting of the doors.

### CROSS-REFERENCE TO RELATED APPLICATIONS

This application claims the benefit of provisional patent application Ser. No. 61/165,111 filed Mar. 31, 2009, which is incorporated herein by reference.

### STATEMENT REGARDING FEDERALLY SPONSORED RESEARCH

Not Applicable.

### BACKGROUND OF THE INVENTION

This invention relates generally to a top hung door assembly for a cabinet and particularly to an assembly which can be used for glass fronted display cabinets for beverages, food products and the like.

In the prior art and, for example, in a patent owned by the assignee of the present application, namely, U.S. Pat. No. 3,328,106 Self-Closing Cabinet Doors is known. This particular patent, utilizes an offset counterweight system having a double bent guide tube which directs the sash-line through two 90° turns and is essentially a bottom supported, guided door.

As pointed out in U.S. Pat. No. 3,328,106 the use of pulleys had not proved successful because the sash-line tends to slip off the pulleys, which was a problem solved by the use of a double bent guide tube. On the other hand, the guide tube does not have the relatively frictionless free motion of a pulley system such as a ball bearing pulley system.

The prior art discloses several examples of top hung doors. However, there are none known which have the combination of features that the present top hung system reveals. For example, U.S. Patent Publication No. 2007/0101540A1 discloses a top hung elevationally adjustable wheel system suitable for a shower door. However, this system does not reveal a door suitable for a merchandiser and having the combination of features that this system has such as a metal stiffening member, or an auxiliary track member or wheel mounting brackets.

The present invention overcomes the disadvantages of the known prior art systems.

### SUMMARY OF THE INVENTION

The present Top Hung Mounted Rolling Sliding Door System overcomes the disadvantages of the prior art sliding door systems by providing a top hung door which has an upper mounting used in conjunction with a lower guidance system. The upper mounting system includes an upper track member having depending flanges with wheel mounting portions receiving a pair of spaced rollers each having a bracket with a lower portion connected to the door frame and an upper portion carrying a wheel received by the roller mounting portion.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an elevational view of a merchandiser;

FIG. 1A is a perspective view of a prior art system;

FIG. 2 is a cross-sectional view taken on line 2-2 of FIG. 1;

FIG. 3 is an enlarged fragmentary view of FIG. 2;

FIG. 4 is an elevational view of the outer door;

FIG. 5 is an elevational view of the inner door;

FIG. 6 is a top view of the inner door;

FIG. 7 is a view of the auxiliary track illustrating the positioning of the roller brackets relative to the notches during door installation;

FIG. 7A is an enlarged fragmentary cross-sectional view taken on line 7A-7A of FIG. 7 illustrating the roller positioning during the door mounting;

FIG. 8 is an elevational view of a roller;

FIG. 9 is a cross-sectional view taken on line 9-9 of FIG. 8;

FIG. 10 is an enlarged view of a roller mounting bracket and a door stop installed on the outer door frame taken from the outside of the merchandiser (track omitted);

FIG. 11 is a cross-sectional view taken on line 11-11 of FIG. 10;

FIG. 12 is a view of a roller mounting bracket and a door stop installed on the inner door frame and taken from the inside of the merchandiser;

FIG. 13 is a view of the sash taken on line 13-13 of FIG. 12; and

FIG. 14 is a view of a pulley assembly.

Corresponding reference numerals indicate corresponding parts throughout the several figures of the drawings.

### DESCRIPTION OF THE PREFERRED EMBODIMENT

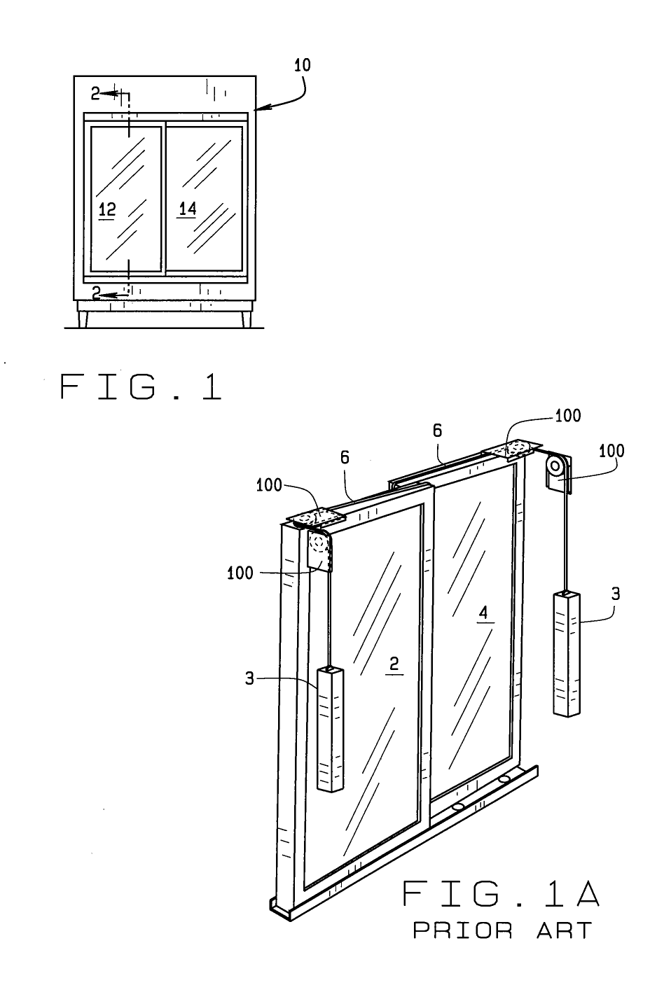

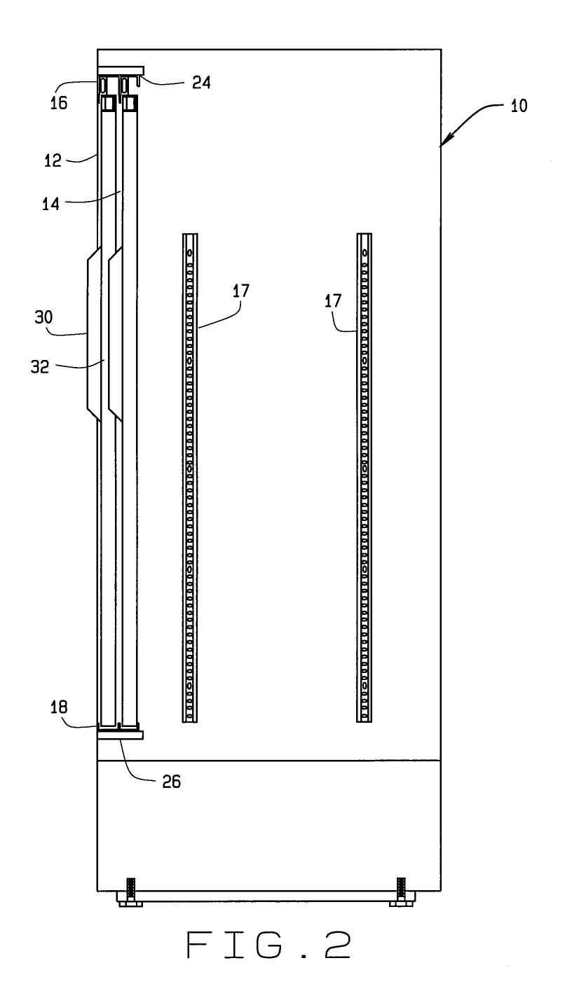

Referring now to the drawings and first to FIGS. 1 and 2 it will be understood that the merchandiser 10 is a refrigerator of the type found throughout mall stores but particularly at checkout locations adjacent the checkout counters for dispensing candy bars, beverages and similar snack items.

In general, the merchandiser in question includes a display area provided with shelves (not shown) which are carried by interior shelf supports 17. It will be understood that the merchandisers 10 have a pair of adjacent outer and inner sliding doors 12 and 14 equipped with door pulls 30 and 32 shown in FIG. 2 by which the doors are opened. Track members 16 and guide members 18 are provided, said track members 16 and guide members 18 being aligned vertically. Distinguishing from prior art systems of the type shown in FIG. 1A, which provide a bottom guide and roller door support system, the present door relies on a top hung system.

In this system the track members 16 and guide aligned members 18 extend essentially the full length of the merchandiser 10 and are supported respectively by longitudinal members 24 and 26 of wood attached to the merchandiser body.

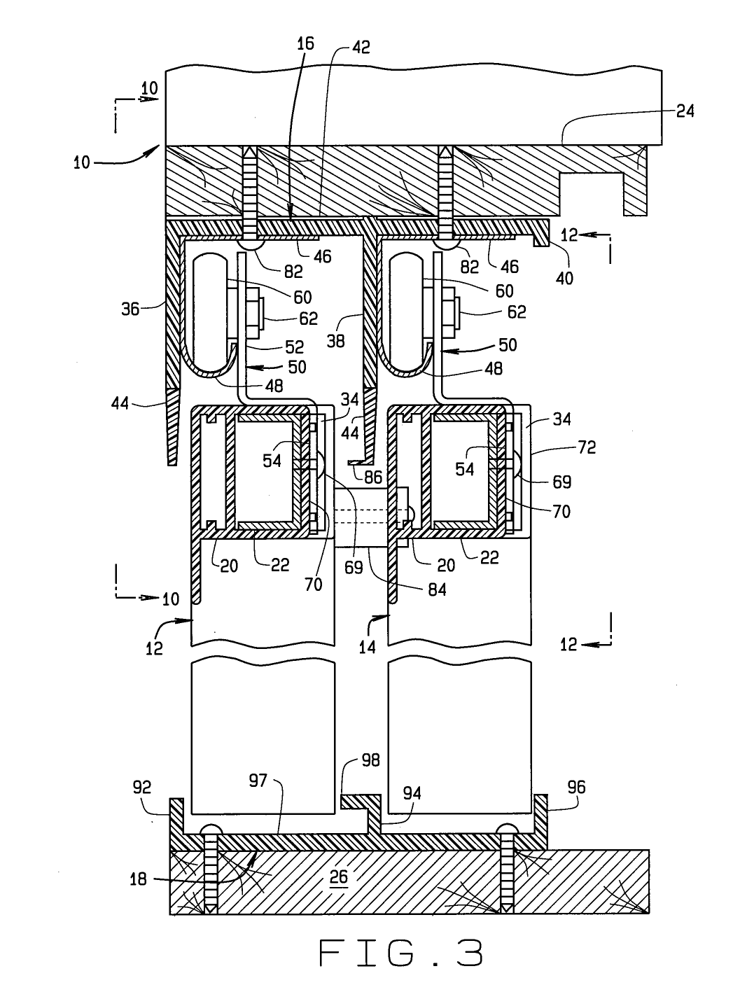

The top hung support system will now be particularly described by reference to FIG. 3, FIG. 7 and FIG. 7A. The track 16 is formed by two depending flange members 36, 38 and a stub member 40 connected by a web 42, all of plastic material. It will be observed that each of the depending flange members 36 and 38 includes a protective flexible tip 44 of bendable plastic material, such as polyone C75A0 Black Flex vinyl, molded onto the respective flange members 36 and 38 adjacent the associated doors 12 and 14. As shown in FIG. 7, the door is lifted into an incipient mounted position. As shown in FIG. 7A the rollers are swung into position by bending the relatively flexible material of the tip 44 until the rollers, once received by the notches 49 and then lowered into place in the J-shaped portion of the 48 of the tracks 46, support the doors 12 and 14. At this point the flexible portion 44 straightens out and, in effect, covers the gap between the top of the door and bottom of the track 48 as shown in FIG. 3.

Additionally, each of the doors 12 and 14 includes a hollow upper plastic door frame 20 provided with a metal reinforcing stiffener 22, which is channel-shaped in the preferred embodiment. Lower member 18 includes vertical flange members 92, 94 and 96 aligned with flange members 36, 38 and 40 respectively, and connected by a web 97.

Identical auxiliary roller tracks 46 are provided for each track member 16. Each auxiliary track 46 is formed from relatively thin sheet metal and includes at its lower end a j-shaped portion 48, which is attached to its associated flange 36 and 38 to automatically center the roller 60 received by it. Tracks 46 are adjustably attached to the track member 16 as by fasteners 82, in the embodiment shown, extending through slots 83. Notches 49 (FIG. 7A) facilitate the placement of the doors 12 and 14.

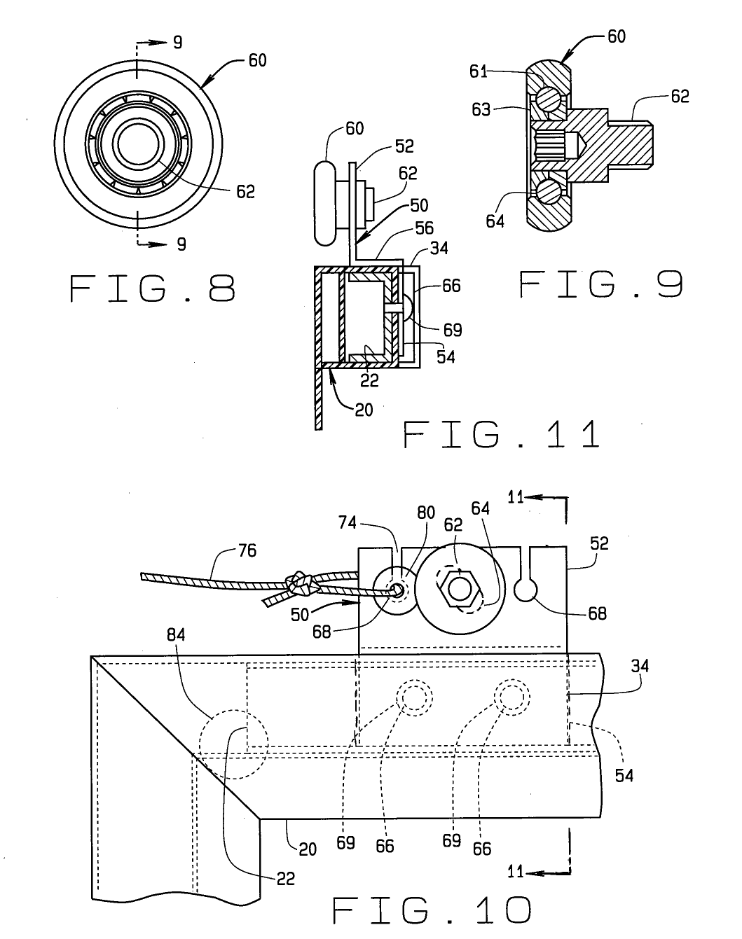

The rollers 60, shown in FIG. 3, and in detail in FIGS. 7-9 and 7A, are attached to a bracket 50 shown extending from the roller 60 to the upper door frame 20 which, in the preferred embodiment is of plastic. As shown, the metal bracket 50 includes an upper portion 52, which carries the roller 60 and a lower portion 54, which is attached to an inner web of the frame 20 by virtue of a recess 34.

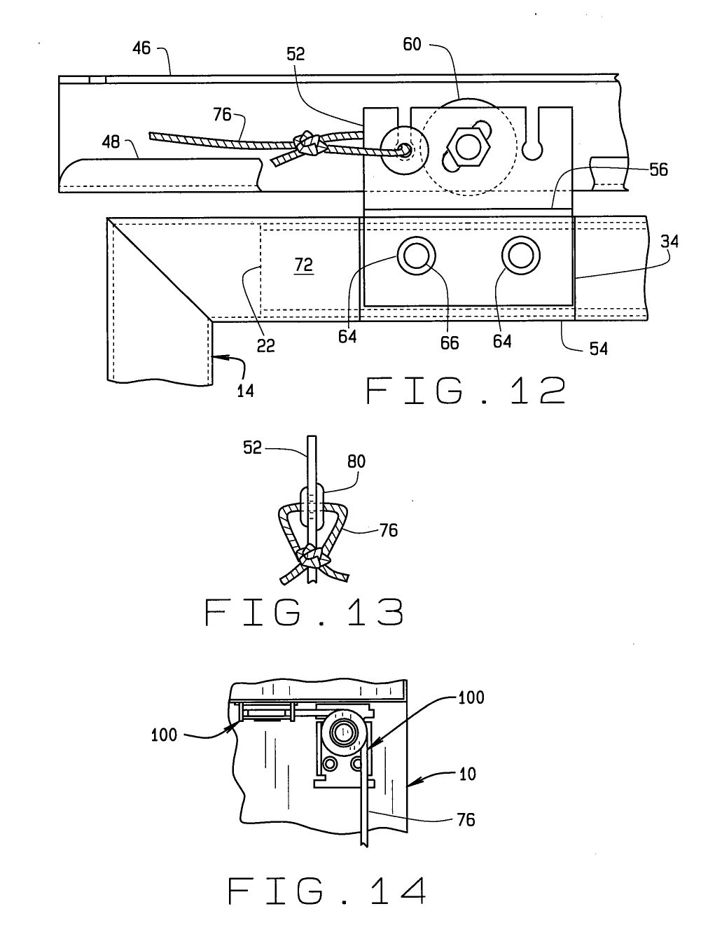

As shown in FIG. 3 the upper frame portion 20 of the doors 12 and 14 includes intermediate partitions 70. Also as shown in FIG. 3 there is a space between the outer wall 72 and the intermediate partition 70. This arrangement permits a recess 34 to be provided by cutting away a portion of the outer wall 72 and the top and bottom walls. The lower portion 54 of the bracket 50 is fitted into recess 34 and fastened to the partition 70 and also to the bight portion of the channel-shaped stiffener 22 by means of the two fasteners 69. The bracket 50 is thus firmly secured to the metal stiffener bight portion as clearly shown in FIG. 12.

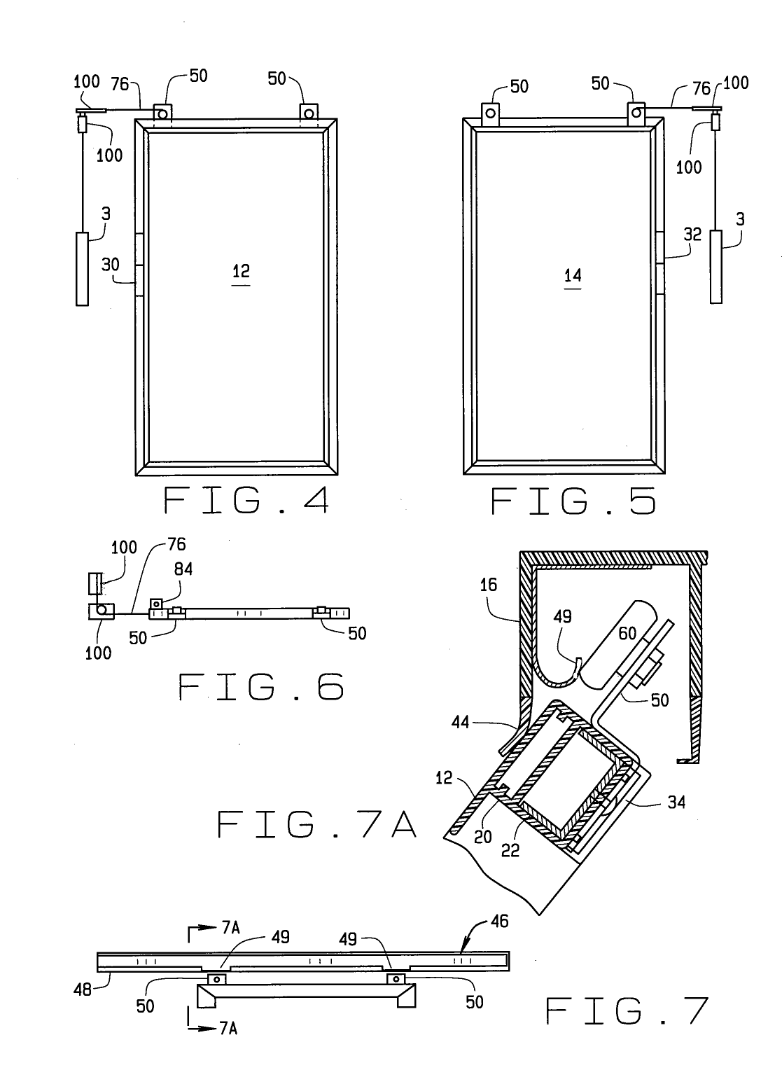

As also shown in FIG. 3 the roller wheel 60 is attached to the upper bracket portion 52 by an inner stud 62 disposed between the inner race 63 and outer race 61, said races being provided with balls 64. The bracket 50 includes two upper holes 68, which are opened to the upper margin 74 of the bracket upper portion 52, and sized to receive a plastic grommet or bushing 80 for attachment of the sash or door cord 76. This feature is best shown in FIG. 10 which is a view taken from the outside of the merchandiser and it will be understood that the grommet protects the sash line 76 against fraying. As also shown in FIG. 10 the bracket 50 includes an inclined slot 64, which is provided to receive the roller stud 62 in elevationally adjustable relation. The bracket upper portion 52 and lower portion 54 are connected by an intermediate plate portion 56 and the bracket 50 is preferably formed from a single bent plate. The bracket 50 lower portion 54 is connected to the plastic upper frame 20 and to the metal reinforcing member 22 of the associated door 12 or 14 by fasteners 69 through holes 66. FIGS. 4-6 also show the sash line arrangement.

FIG. 12 is another view of the bracket assembly from the inside of the merchandiser. As shown, the bracket 50 is inserted into a recess formed in the vertical plastic wall of the upper door frame member 20 and indicated by numeral 34 in FIGS. 11 and 12. The first door 12 is fitted with a stop 84 to limit the movement of the second door 14.

A counterweight system is attached to the end of the sash line 76 similar to that shown in FIG. 1A which is taken from commonly owned U.S. patent application Ser. No. 11/110,558 which is incorporated herein by reference. FIG. 10-13 illustrate the arrangement of the sash line at the grommet 80 having a knotted loop attached to the upper bracket portion at one end protected by the grommet 80 and attached to a counterweight at the other end as shown in FIGS. 4-6.

As shown in FIG. 3 the lower flexible portion 44 of the track includes a turned end 86 to assist in air sealing the doors at the upper end. The lower guide includes upstanding flanges 92, 94 and 96 connected by a web 97 which includes a turned end 98 to assist in air sealing the doors at the lower end. At least one door has a bumper stop 84 limiting movement of the door.

It is thought that the functional advantages of this top hung sliding door assembly have become fully apparent from the foregoing detailed description of parts, but for completeness of disclosure, the installation and operation will be briefly described.

The top hung sliding door assembly 10 is comprised essentially of a pair of doors 12 and 14, constituting first and second overlying adjacent doors, riding in an upper track 16 for movement between open and closed limits, each door including a door pull 30 and 32. The top hung nature of the doors 12 and 14 provides that the vertically aligned track member 16 and guide member 18 may be preinstalled in the merchandiser by virtue of longitudinal members 24 and 26, respectively.

The doors 12 and 14 are fitted with two brackets 50 each, the lower part of the bracket indicated by numeral 54 being attached in the door frame recesses 34 by fasteners 66 received into the openings 69. The brackets 50 each have roller wheels 60 pre-attached to the upper bracket portion 52. The auxiliary track members 46 are previously emplaced in the tracks 16 by virtue of fasteners 82 by way of slotted holes 83 which permit lateral adjustment of the track member 46 relative to the track 16 and, because of the j-shaped portions, the rollers 60 move automatically to a central position as shown in FIG. 3. Also the auxiliary track members 46 with notches 49 (FIG. 7 and FIG. 7A) permit the doors 12 and 14 to be easily lifted into position. The positioning of the doors relative to the track 46 is facilitated by the bendable flexible tips 44 which, when the doors are emplaced return to their original non-bent position protect and seal the doors against unnecessary air flow. Importantly, each plastic upper door frame member 20 has an elongate metal stiffening member 22 which strengthens the plastic frame member and permits the bracket 50 to be secured to the door frame and the stiffening members. Also, the brackets 50 have inclined slots for adjusting the elevation of the doors 12 and 14.

The lower flexible portion of the track 16 includes a turned end 86 to assist in air sealing the assembly. The lower guide portion includes a turned central portion 98 to assist in air sealing the assembly. At least the first door has a bumper stop 84 limiting movement of the second door 14.

Although the invention has been described by making detailed reference to a single preferred embodiment, such detail is to be understood in an instructive, rather than in any restrictive sense many variations being possible within the scope of the claims hereunto appended.

I claim as my invention:

1. A top hung door assembly for a merchandiser comprising:
an upper track member including at least one depending member;
said at least one depending member providing a roller mounting portion;
a door including a pair of spaced roller assemblies each including a bracket having a lower portion operatively connected to the door and an upper portion carrying a roller received by the roller mounting portion;

2. A top hung door assembly as defined in claim 1 wherein the track member includes an auxiliary track portion providing the roller mounting portion.

3. A top hung door assembly as defined in claim 1 wherein the track member includes at least one depending member having a flexible lower portion to facilitate mounting the door.

4. A top hung door assembly as defined in claim 3 wherein the flexible portion includes a turned end assisting in sealing the track member and the door against air flow.

5. A top hung door assembly as defined in claim 2 wherein the auxiliary member includes a J-shaped portion providing the roller mounting portion.

6. A top hung door assembly as defined in claim 1 wherein each bracket upper portion includes an inclined slot receiving a roller stud in elevationally adjustable relation.

7. A top hung door assembly for a merchandiser comprising:
an upper track member;
the track member including two depending flange members and a connecting web member, at least the two flange members including an auxiliary track portion having a roller mounting portion;
a pair of doors each including a pair of spaced roller assemblies, each roller assembly including a bracket having a lower portion operatively connected to a door and an upper portion carrying a roller received by the auxiliary track mounting portion.

8. A top hung door assembly as defined in claim 7 wherein each door includes a plastic upper member having an elongate stiffening member.

9. A top hung door assembly as defined in claim 8 wherein the elongate stiffening member is a metal channel.

10. A top hung door assembly as defined in claim 7 wherein each bracket upper portion includes an inclined slot receiving a roller stud and providing the door with elevational adjustment.

11. A top hung door assembly as defined in claim 7 wherein each auxiliary track includes two lengthwise spaced notches to facilitate mounting the roller assemblies.

12. A top hung door assembly as defined in claim 7 wherein each bracket has at least one opening for a sash line attached to the upper portion of the bracket, the bracket opening being provided with a grommet protecting the sash line and facilitating providing the sash line with a knotted loop.

13. A top hung door assembly as defined in claim 7 wherein at least one flange member includes a bendable lower flexible portion facilitating mounting the door.

14. A top hung door assembly as defined in claim 13 wherein the at least one protective flexible lower portion has a turned sealing tip providing an air seal for the door.

15. A top hung door assembly as defined in claim 7 wherein a door guide includes channel means receiving and guiding the bottom of the door.

16. A top hung door assembly as defined in claim 15 wherein the door guide member includes upstanding flanges, at least one flange having a turned portion providing an air seal for the door.

17. A top hung door assembly as defined in claim 7 wherein at least one door includes a bumper stop limiting movement of the other door.

18. A top hung door assembly as defined in claim 8 wherein the plastic frame member includes an outer member and an inner member and the outer member is at least partially cut away to expose the inner member so that the bracket can be attached to the inner member and the elongate stiffening member.

19. A door assembly as defined in claim 7 wherein the track member includes an associated track member of metal having associated notches spaced to receive the roller assemblies to facilitate mounting the doors.

20. A door assembly as defined in claim 7 wherein each track member includes an associated track member of metal having a plurality of slotted holes to facilitate lateral adjustment of the track member bar.
